(19) United States
(12) Patent Application Publication
(10) Pub. No.: US 2026/0105330 A1
(43) Pub. Date: Apr. 16, 2026

(54) System and Method for Knowledge Graph Embedding into AI Model

(71) Applicant: Kobai, Inc., San Ramon, CA (US)

(72) Inventor: Ryan Oattes, Burlington (CA)

(21) Appl. No.: 19/357,909

(22) Filed: Oct. 14, 2025

Related U.S. Application Data
(60) Provisional application No. 63/706,986, filed on Oct. 14, 2024.

(51) Int. Cl. G06N 5/04

(52) U.S. Cl. CPC G06N 5/04

(57) ABSTRACT

A method for ontology-guided question answering is disclosed. A system stores a graph-ontology data structure comprising concept nodes, property nodes linked to respective concepts, inter-concept links, and instance data. Upon receiving a natural-language query, the system generates a query embedding using at least one large language model (LLM). The system identifies candidate sub-graphs of the ontology and, using at least one LLM, produces respective embeddings for those candidates. A particular sub-graph is selected via vector comparison to the query embedding. The selected sub-graph is compiled into an ontology-based query and query is performed over the instance data to obtain structured results. The system generates a displayable answer, optionally with an intermediate sub-graph view.

### REFERENCE OTHER APPLICATIONS

This application claims priority to U.S. Provisional Application No. 63/706,986, filed Oct. 14, 202, which is herein incorporated by reference.

### BACKGROUND

This disclosure is related to systems and methods for data processing using Knowledge Graph data structures.

### SUMMARY

Data storage and retrieval systems face barriers to adopting emerging large-language-model (LLM)-based “chat interfaces” for answering questions. Problems include an inability to answer questions correctly across private (non-public) data (e.g., private databases); scale and cost issues associated with large-scale adoption of vector databases leading to poor system performance; and a lack of transparency into the methodology, which prevents evaluating the validity of LLM-provided answers. For example, when an LLM produces a chatbot answer, there is no proof or evidence of correctness, and the answer can easily be an AI hallucination. This defeats the purpose of using the LLM, as the answer cannot be relied upon, nor can troubleshooting be performed for poor answers.

To address these problems, a Knowledge Graph Embedding (KGE) method and system for answering questions against a knowledge graph using LLMs is provided.

In some embodiments, the LLM system is configured to work with a knowledge graph (e.g., a data structure of semantic concepts and features, such as the semantic overlay data structure described below). In some embodiments, the system performs Query Discovery by accepting (e.g., via a UI on a user device) a natural-language user query (i.e., a question in English) and converting it (e.g., by a server connected via a network to the user device) into a high-level visual representation of the “sub-graph” in the knowledge graph required to answer the question. In some embodiments, semantic concepts may also be referred to as “classes.”

In some embodiments, the system generates, for display on the user device, a visual graphical interface element that allows confirmation feedback. For example, the system may provide a graph visualization of the classes/concepts from the ontology and their required properties/aggregates. This enables user-interface inputs confirming that the model has understood the intention of the natural-language user query. In one approach, the ontology has been authored by the user's organization, resulting in feedback in a format understandable to the user. This provides assurance that the system has not hallucinated and/or misinterpreted the question. In some embodiments, such an “intermediate representation” of the graph query or sub-graph is not merely a formal/textual graph query in Cypher or an underlying SQL query.

In some embodiments, the system automatically troubleshoots the query. For example, if the initial intermediate representation relies on concepts or features in the knowledge graph with sparse or no data, the system may substitute other concepts or features with higher data density. For example, the system may discard the suggested sub-graph entirely and move on to a second/third match as more appropriate.

In some approaches, the system provides UI inputs for flagging (e.g., thumbs-up, thumbs-down interfaces) individual classes or properties to keep/discard and for initiating another iteration of sub-graph/query suggestion based on this feedback.

In some approaches, once user-interface confirmation is received for the suggested graph query, the query is converted to an executable form and run against a knowledge-graph store, returning a structured (e.g., tabular) data output to the user. In some embodiments, the system pre-emptively assumes the first suggestion is valid. In one approach, this is a deterministic output, and re-running the same query will always provide the same answer. The system can prepare lineage diagrams tracing this output deterministically back to raw inputs that may have been ingested into the knowledge graph.

In some approaches, this output can be fed into a chat-based LLM as prompt context along with the original question. This returns to a RAG strategy—the final summary response to the user may be non-deterministic but will likely be higher quality given the method of retrieving the data versus a simple RAG pipeline with semantic matching to chunks of raw data. In some embodiments, both the tabular output and the chat-style answer are provided.

In some embodiments, other algorithms can be run and visually presented to the user to evaluate the relative reliability/value of the data retrieved from the knowledge graph. This includes lineage analysis and query troubleshooting (e.g., identification of unpopulated or poorly populated nodes in the graph).

In some embodiments, a Data Processing Engine (DPE) executes on a server (e.g., DPE may be an application running based on instructions stored in non-transitory memory), a user device, or a combination of the two to provide techniques for answering natural-language queries using a knowledge graph. The techniques combine the best features of LLM systems and graph-based semantic queries by providing the ability to answer questions while preserving fidelity and exposing the sources of the answer in the user interface. In some embodiments, the DPE may access a local or remotely stored non-transitory memory that maintains a data structure (e.g., a knowledge graph) of semantic concepts and properties. The DPE may include or access (e.g., via an API) an LLM or another embedding service that generates vector embeddings based on text inputs, which may be used by the DPE as discussed below.

The DPE may access the data structure that corresponds to an ontology (e.g., a knowledge graph) comprising a plurality of concept nodes, where each concept has its own set of property nodes. Each concept node is connected to one or more property nodes representing attributes or relations. The data structure may also include instance data for a plurality of instances of each concept node, enabling query resolution over concrete records rather than solely abstract schema. For example, in the schema, the concept “teacher” may have properties: age, school, class assignment, etc. Instances of the concept may include N teachers, each with respective properties (e.g., teacher “Mr. Johnson” may have properties “Age=32,” school=“East High,” etc.).

In some embodiments, the DPE receives, via its user interface (e.g., a web UI or API), a free-form natural-language question. The DPE normalizes the text (e.g., via tokenization, language detection if needed, and light cleanup) and forwards the text to the embedding service or uses its own embedding function.

In some embodiments, the embedding service (e.g., part of the DPE or accessed by the DPE) uses at least one LLM (or an LLM-backed encoder) to produce a query vector representing the semantics of the user's question. The DPE may maintain model identifiers and versioning to ensure that queries (and other data) are embedded into the same semantic space with the same number of dimensions.

In some embodiments, the DPE analyzes the graph ontology to identify multiple candidate sub-graphs whose topology (concepts, properties, relations, and optional aggregates) could satisfy the query's information need. Discovery may be performed in a variety of ways, discussed in more detail below. In some embodiments, query discovery is performed at run time. In other embodiments, candidate queries may be discovered ahead of time and stored for access.

In some embodiments, for each candidate sub-graph, the DPE creates a candidate embedding using the at least one LLM in the same embedding space and with the same dimensions as those used for the query. The input to the encoder can be a heuristic description of the sub-graph (and/or one or more semantic variants of the description generated by the at least one LLM). This produces a comparable vector for each candidate sub-graph of the ontology (e.g., the knowledge graph).

In some embodiments, the DPE computes vector similarities (e.g., cosine similarity) between the query vector and each candidate vector to select one or more best-matching sub-graphs. The selected sub-graph serves as the intermediate representation of user intent.

DPE may generate an ontology-based query using a variety of techniques. The query generator compiles the selected sub-graph into an executable ontology-based query appropriate for the backing store (e.g., SPARQL for RDF Resource Description Framework triple stores). In some embodiments, the selected sub-graph may also be programmatically compiled into an SQL query or any other suitable query for database lookups. Compilation preserves the semantic bindings from concept nodes to instance tables/collections and from property nodes to concrete fields. In some embodiments, parts of the user query may also be used as filters for the data derived from the sub-graph structure (e.g., words of the query that did not semantically match concepts or properties).

In some embodiments, the DPE executes the ontology-based query against the knowledge-graph store to obtain structured results. The UI of the DPE may generate a natural-language answer (e.g., by inputting the structured results into the at least one LLM). The DPE may also optionally generate for display one or more of: (i) the intermediate sub-graph visualization, (ii) the created knowledge-graph query, and (iii) confidence and coverage indicators (e.g., which properties were populated vs. sparse). In some embodiments, the structured results are optionally supplied to a chat-style LLM to synthesize a natural-language summary while preserving links back to tabular deterministic results. In some embodiments, portions of the tabular data that were used to build the ontology are generated for display as well.

In some embodiments, the UI of the DPE can accept confirmation or corrections (e.g., keep/discard specific classes or properties) shown in the UI and automatically re-run the query. In some embodiments, the DPE may also show alternative ontology-based queries from the candidate set. In some embodiments, the DPE may also show matching historical user-generated ontology-based queries that were used in the past.

In some embodiments, by constraining answer generation to (a) a selected ontology sub-graph chosen via measurable vector comparison, and (b) an executable ontology-based query over concrete instances, the DPE grounds outputs in verifiable data. The intermediate representation is inspectable, the compiled query is deterministic, and the resulting table is reproducible—together providing transparency and proof paths that generic LLM chat lacks. When a chat-style summary is desired, the DPE treats the LLM as an additional tool to convert graph-based answers to conversational output. In this way, the LLM is not used as a free-form oracle, thereby reducing hallucinations, improving fidelity, enabling rigorous troubleshooting (e.g., via audit logs), and lowering cost by avoiding indiscriminate vectorization and retrieval over unstructured corpora.

### BRIEF DESCRIPTION OF THE DRAWINGS

FIG. 1 is an example block diagram of an illustrative system and data storage for ontology-guided question answering techniques in accordance with some embodiments.

FIG. 2 is an example flow chart for retrieval augmented generation (RAG) approach to LLM processing, in accordance with some embodiments.

FIG. 3 is an example flow chart for processing textual queries using Knowledge Graph Embeddings, in accordance with some embodiments.

FIG. 4 is a diagram of an illustrative user interface for processing a natural-language query from a user device, in accordance with some embodiments.

FIG. 5 is another diagram of an illustrative user interface for processing a natural-language query from a user device, in accordance with some embodiments.

FIG. 6A is an illustrative block diagram of a device used in accordance with some embodiments.

FIG. 6B is an illustrative block diagram of a system, used in accordance with some embodiments.

FIG. 7 is an illustrative data structure, in accordance with some embodiments.

FIG. 8 is another diagram of an illustrative user interface for processing a natural-language query from a user device, in accordance with some embodiments.

FIG. 9 is an illustrative example of generating an ontology-based query, in accordance with some embodiments.

FIG. 10 is an illustrative example of generating candidate graphs for a natural language based query, in accordance with some embodiments.

FIG. 11 is a flowchart of an illustrative method for answering a natural language based query, in accordance with some embodiments.

### DETAILED DESCRIPTION

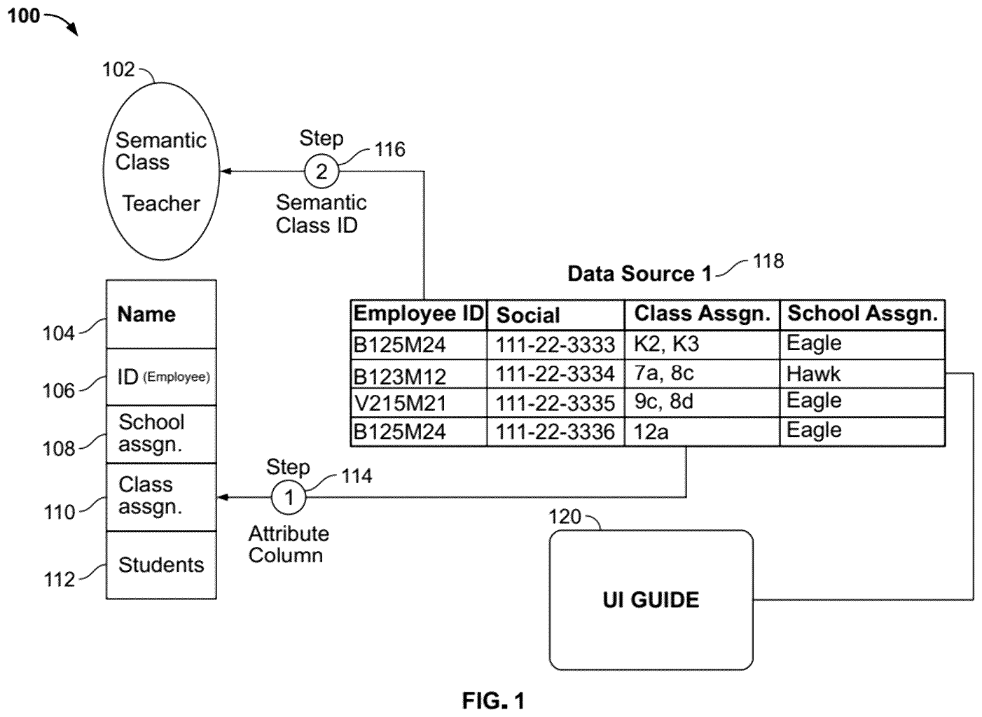

FIG. 1 shows an illustrative mapping process 100 for creating a semantic overlay data structure, in accordance with some embodiments of the disclosure. In some embodiments, the mapping process may be performed by a Data Processing Application (the DPE). In one approach, the DPE is embodied in a set of instructions stored in non-volatile memory of a single server or in a set of servers acting in parallel (e.g., in a distributed computing environment). The processors of the server or servers execute the instructions stored in non-volatile memory to enable the operation of the DPE. The DPE may interface with data stored locally or on a remote device or devices accessible via at least one network.

The systems and methods performed by the DPE described herein generate and use a semantic overlay data structure (which may also be referred to as a semantic model) that provides a level of abstraction for traditional data sources (e.g., tables, databases, lists) such as first data source 118. The method of creating overlay data structures is described in more detail in the '857 Publication (U.S. Patent Publication No. 2020-0210857 incorporated herein by reference). For example, first data source 118 may comprise a table listing data for teachers in a school district. As shown, first data source 118 includes several columns for multiple teachers, such as social security number, class assignment, school assignment, etc. One skilled in the art would appreciate that such a table may include any suitable number of columns tracking any suitable data for teachers in the school districts. In some embodiments, rows may be used to track data instead of or in addition to columns.

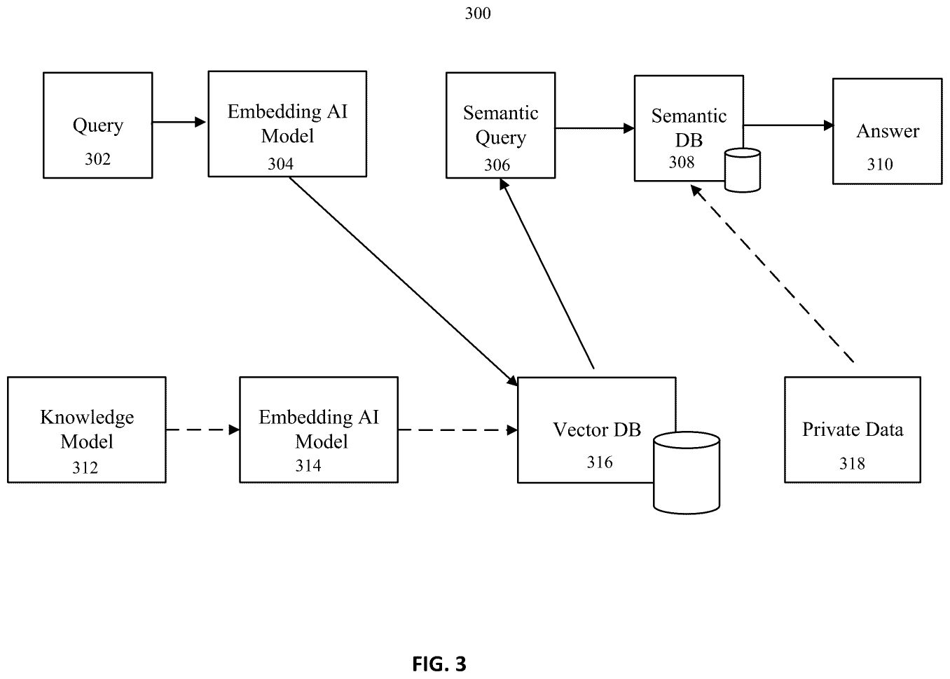

The DPE may operate to ingest first data source 118 (and any other traditional data sources) into a semantic overlay data structure. The semantic overlay data structure may define a plurality of semantic classes (e.g., “teacher,” “school,” “student”). Some exemplary semantic classes are further shown, e.g., in FIG. 3 of the present disclosure. Each semantic class may comprise a list of attributes. For example, the semantic class “teacher” 102 may comprise a name attribute 104, ID attribute 106, school assignment attribute 108, class assignment attribute 110, and students attribute 112. One or more of the attributes may be connections to other semantic classes. For example, the “students” attribute 112 may be a link to one or more semantic classes' instances of the semantic class “Student” (e.g., by linking to an ID of those instances). Similarly, the “school assignment” attribute 108 may be a link to one or more semantic classes' instances of the semantic class “School.” The semantic overlay data structure may be defined and stored as a graph data structure that identifies every semantic class in the model and indicates all connections between the semantic classes (e.g., as edges between nodes of a graph). The semantic overlay data structure may also define the list of attributes for every semantic class (e.g., as data stored in association with each node of the data structure). The semantic overlay data structure may be incrementally defined using User Interface (UI) Guide 120 (e.g., as further described in the '857 Publication). For example, the user interface input from UI guide 120 may create a number of nodes, name the nodes, and draw connections between the nodes. The user interface input from UI guide 120 may then be used to define attributes for each node (e.g., by clicking a node and inputting names of the attributes).

Each semantic class in the model may be associated with multiple instances of that semantic class. For example, as shown, four instances of semantic class “teacher” 102 may be created by the system based on four teachers being listed in the first data source. Advantageously, instances of semantic class “teacher” 102 may also be created based on any number of traditional data sources. Each instance of semantic class “teacher” 102 may be assigned a semantic class instance ID. Such instance ID may be used by the search system to uniquely identify each class instance. Because instance ID uniquely identifies each class instance such IDs may further be used to create unique links between semantic class instances (e.g., a link from an attribute may be defined to point to another semantic class instance, for example by storing ID of the linked semantic class instance as one of the attributes).

Once the structure of the semantic overlay data structure is defined, data from one or more data sources (e.g., first data source 118) may be ingested into the semantic overlay data structure (e.g., to create semantic class instances for each defined sematic class). The ingestion process may be assisted using UI guide 120. For example, items in columns of first data source 118 are mapped to semantic class attributes 104-112. The user device that interfaces with the DPE may be prompted by UI guide 120 to perform the mapping. For example, UI Guide 120 may guide selections of data for attributes of semantic class 102. FIG. 1 illustrates an exemplary 2-step data mapping using UI guide 120. In one example, first step 114 corresponds to a selection of at least one column from a data source 118 (e.g., class assignment column) to provide attribute values for a selected attribute (e.g., attribute 110). Second step 116 corresponds to identifying the appropriate semantic class and appropriate attribute for that class that is to be mapped to that column. Steps 114 and 116 may be performed in any order or at the same time.

In another alternative approach, the data is ingested from one or more data sources (e.g., first data source 118) into the semantic overlay data structure only when a query is received. In this approach, the sematic classes, attributes, and connections between the sematic classes may be defined ahead of time, however the actual instances of the classes may be generated in real time when required (e.g., when a query is formed, such as at element 304 of FIG. 3). In some embodiments, a hybrid approach may be used, e.g., some data sources may be ingested ahead of time, while other data is ingested as needed.

For example, the illustrated example shows a mapping of “Class Assignment” attribute 110 in the semantic overlay data structure to the “Class Assgn” column in the Data Source 118 source table. In this example, a user interface can be used to drag “Class Assignment” attribute 110 over the “Class Assgn” Column of Data Source 118. In one embodiment, the user interface displays a prompt to identify how Data Source 118 relates to the semantic class “Employee” 102 in the overlay data structure. For example, the user interface may generate a prompt to indicate how each employee is uniquely identified in Data Source 118. In this case, the “Employee ID” column may be selected as unique identifier of Sematic Class “Teacher” instances (which may match “ID” attribute 104). In this way columns of the first data source 118 may be mapped to attributes of instances of semantic class 102. One skilled in the art would appreciate that this process may be performed for any number of data sources and for any attributes of any number of defined semantic class. For example, different columns of many different data sources may be mapped to attributes of semantic classes “teacher,” “school,” and “student.” In some embodiments, multiple columns of multiple data sources are mapped to the same attribute of the same semantic class. In some embodiments, the mapping may also define relations to other instances of other semantic classes. For example, the attribute “school assignment” may be mapped to instances of a semantic class “school” when a connection is defined between semantic class “teacher” and semantic class “school.”

In some embodiments, the ingestion of data from first data source 118 to the semantic overlay data structure that includes semantic class 102 is accomplished by the DPE creating and updating a triplestore purpose-built database for the storage and retrieval of data through semantic queries. For example, the DPE may create triples (which may also be referred to as “triads” or “3-tuples”) based on ingestion of data. For example, triples (e.g., triples suitable for SPARQL Protocol and RDF Query Language (SPARQL)) may include, for each instance of an attribute: unique ID of concept instance to which it belongs, the name of the attribute, the value of the attribute. The triples may then be indexed and used for fast data retrieval. For example, the triples may be data triples defined by W3C RDF 1.1 N-Triples specification (https://www.w3.org/TR/n-triples/) which is herein incorporated into this document in its entirety.

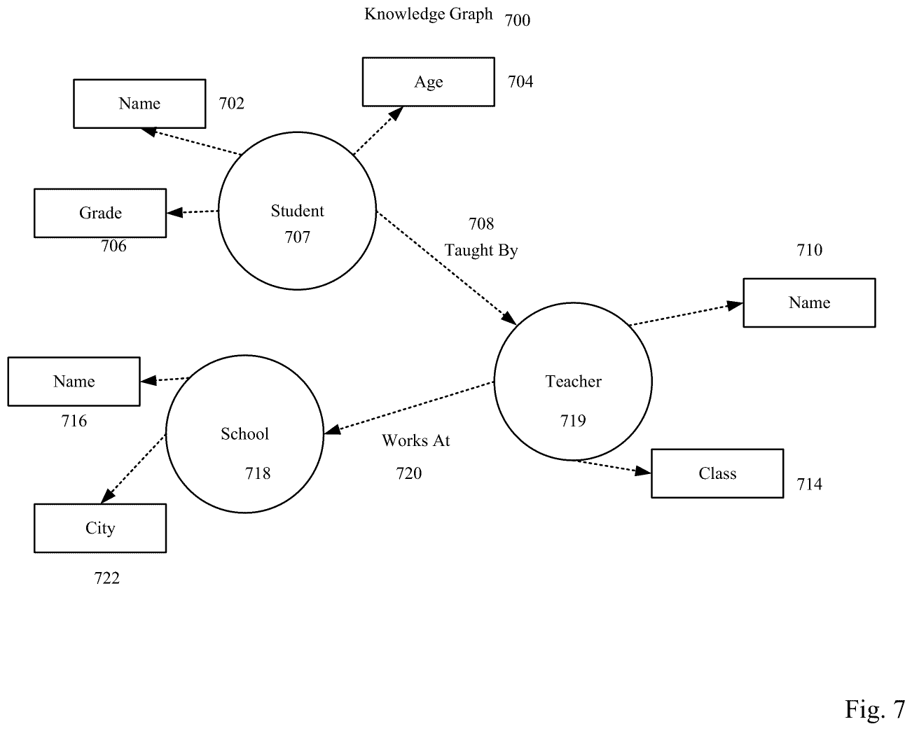

FIG. 7 illustrates an example knowledge graph 700 used by the DPE which may be generated as described above in FIG. 1. Concept nodes (or semantic class nodes as will be used throughout the specification) include Student 707, Teacher 719, and School 718 (circles). Each concept has bound property nodes (rectangles with dotted connectors): Student 707 is associated with Name 702, Age 704, and Grade 706; Teacher 719 is associated with Name 710 and Class 714; School 718 is associated with Name 716 and City 722. Directed inter-concept relations (solid connectors) encode semantic links, including “Taught By” 708 from Student 707 to Teacher 719 and “Works At” 720 from Teacher 719 to School 718. In some embodiments, these properties serve as selectable attributes, filters, or aggregation keys when forming candidate sub-graphs and compiling the ontology-based query.

In some embodiments, each concept node of knowledge graph 700 has a plurality of concrete instances (e.g., individual students, teachers, and schools) stored in association with the ontology. Each instance may be assigned a unique instance identifier and one or more property values (e.g., Student instance S123 with Name=“Ana”, Age=10, Grade=4; Teacher instance T045 with Name=“Mr. Johnson”, Class=“Math 4A”; School instance H002 with Name=“East High”, City=“New York”). The directed relations (e.g., Taught By 708, Works At 720) may also be instantiated between specific instances (e.g., S123—Taught By→T045; T045 Works At→H002). In this way, the ontology (schema) defines allowable concepts/properties/relations, while the instance layer provides the concrete data over which candidate sub-graphs are formed, ranked, and compiled into usable ontology-based queries. Such data structures may be used in combination with LLMs for processing natural language queries to provide provable answers to natural language queries as described above and below.

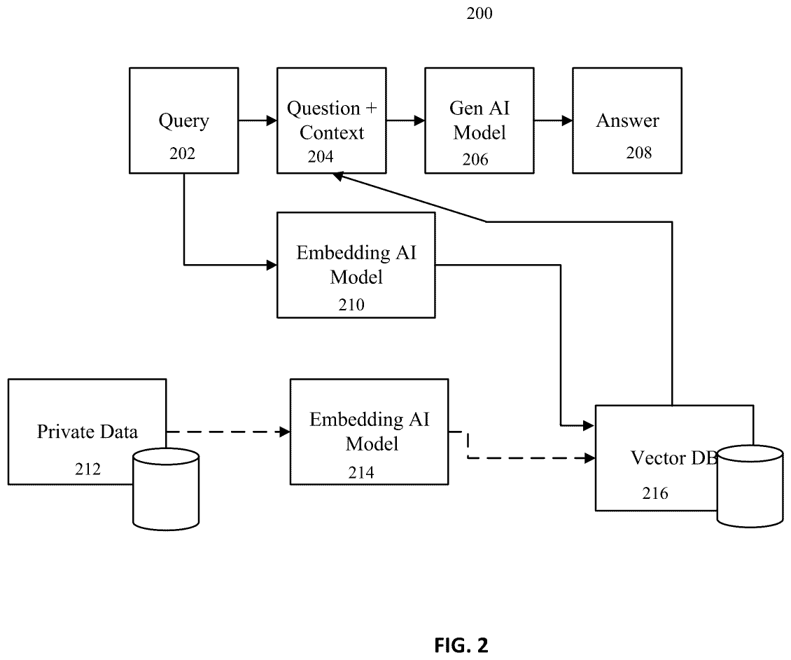

FIG. 2 shows a retrieval augmented generation (RAG) approach to LLM processing. Private data is embedded into the AI model to create vector database. At query time, the query in conjunction with amended AI model are used to create “context+question” query. This is used by a generative AI mode to create a semantic answer. As explained above, this approach is deficient because it provides no proof of the private data being used correctly, meaning that the answer is less reliable and cannot be used in critical situations since the answer could be based on poor data or be a complete AI hallucination.

In some embodiments, an application called Data Processing Engine (DPE) implements a retrieval-augmented generation (RAG) workflow as depicted in flowchart 200. The DPE comprises (i) a preprocessing steps (dashed lines) and (ii) a run-time steps for answering user queries using the embedded corpus (solid lines).

In some embodiments, at pre-processing time the DPE accesses Private Data 212 (e.g., documents, tables, tickets, wikis). The DPE provides the data to an Embedding AI Model 214 to generate a vector representation. The DPE associates each vector with metadata and stores the vectors into a Vector DB 216 where the vectors are stored in an indexed manner. In some embodiments, the DPE periodically repeats this process to reflect additions, updates, or deletions and may maintain up-to-date embedding-model versions.

At run-time, the DPE receives a natural-language Query 202 via a user interface or an API. The DPE uses an Embedding AI Model 210 to transform the query into a query vector in the same embedding space as the corpus vectors stored in DB 216. The DPE submits the query vector to Vector DB 216 and obtains matching results. The DPE forms a composite prompt Question+Context 204 by concatenating the original query with the retrieved data from the vector DB 216. The DPE supplies 204 to a Gen AI Model 206, which produces an Answer 208 that the DPE returns for display.

Such approaches are deficient because they rely on embedded data where no proof of the correct answer be provided. Worse, the results are stochastic, and new results may be produced each time the query is run. To address the problems systems and method are provided herein that use LLM techniques along with graph-based query systems in example embodiments described above and below.

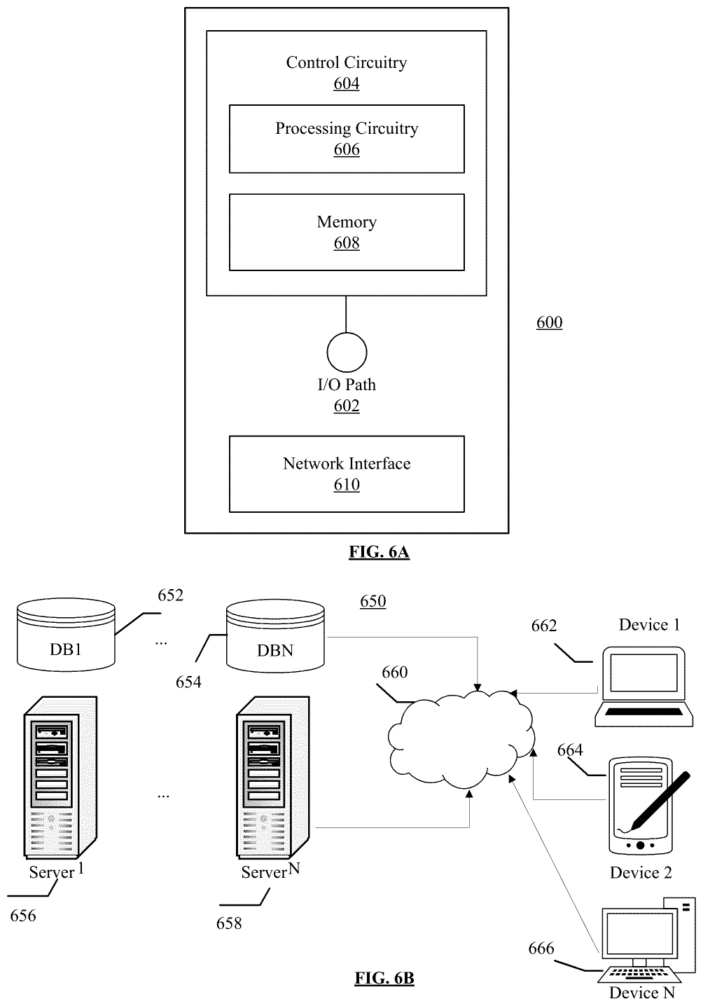

FIG. 3 shows a method 300 for a system for processing textual queries using knowledge Graph Embedding. Up front, the system (e.g. using DPE described above in FIG. 1) may use a knowledge model 312 (e.g., semantic overlay data structure of FIG. 1 or FIG. 7) to perform AI embedding 314 to create a vector DB in a certain vector space. The semantic database may also be configured with the private data 318 (e.g. with the semantic overlay data structure of FIG. 1 and/or associated instance data). These steps may be done by the DPE as pre-processing steps. The data may be stored in memory 608, 652 or 654 of FIG. 6.

At query time, the textual query 302 may be combined with the Embedded AI model 304 in the vector database to generate a graph-based query 306 by a process of Query Discovery that will be described below in more detail. In particular, LLM vector matching techniques may be used to compare embeddings of sub-graphs (e.g., of FIG. 7) to embeddings of the query 302 (e.g., created in the same vector space with same dimensions). Best matching of sub-graphs may be used to create semantic query 306. Other sub-graphs may be used to show alternative queries.

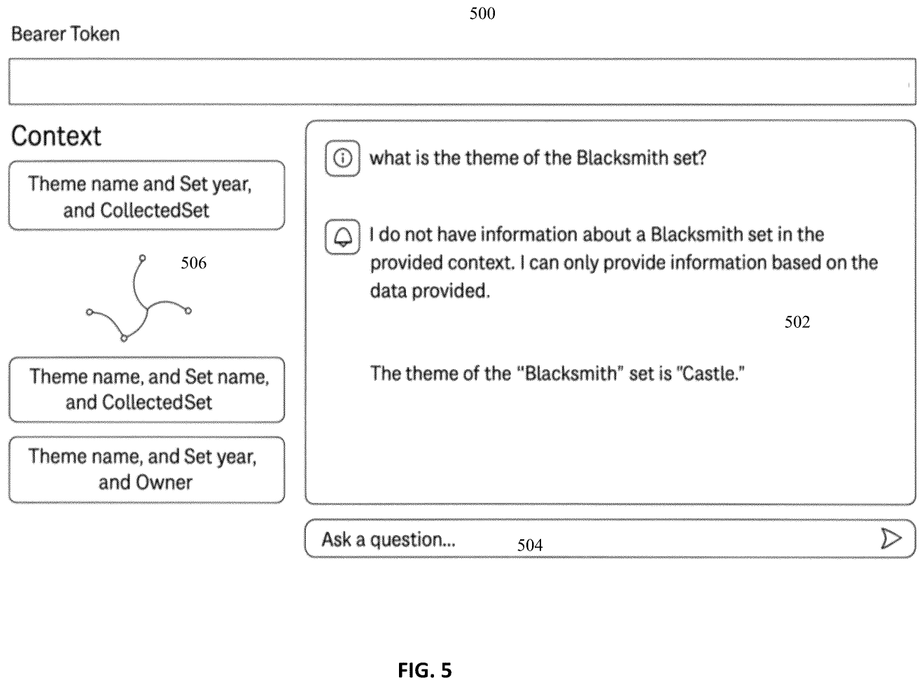

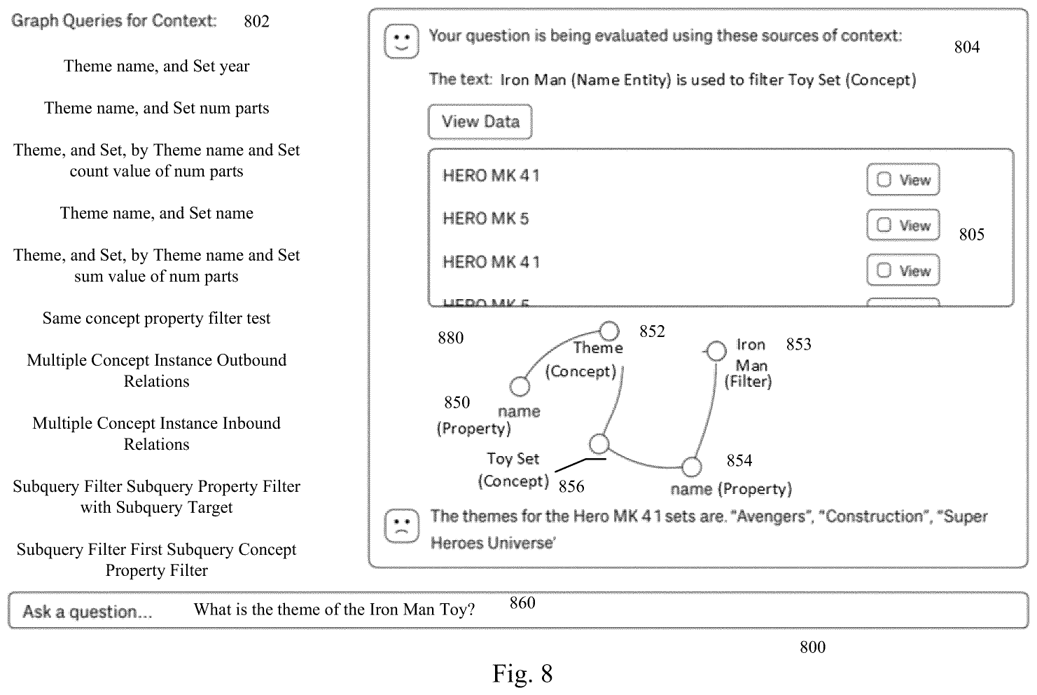

As will be explained below (e.g., in FIGS. 5, 6, and 8 the graph-based query can be shown on the user interface for approval or modifications (e.g., the “sub-graph” in the knowledge graph shown in FIG. 8 required to answer the question). The graph-based query 306 can be used to search semantic databases 308 (e.g., in combination with data 316, as in the RAG approach shown in FIG. 2). The search may be performed using suitable SPARQL techniques for searching for RDF Resource Description Framework triple stores used to store instances for the semantic overlay data structure (e.g., as shown in FIG. 7). In some embodiments, the graph-based query 306 may also be programmatically compiled into an SQL query or any other suitable query for database lookups.

The query 306 can be used to get an answer 310 in a graph or tabular form (e.g., as described in U.S. Pat. No. 12,079,212 which is incorporated herein by reference) by searching the semantic database (e.g., instances stored for the ontology shown in FIG. 7). The answer can be shown in tabular form and/or by DPE inputting that data into a chat LLM to output the answer in conversational form.

Multiple Approaches to Query Discovery are provided. Depending on use case, the Query Discovery process performed by the DPE for creating a graph-based query may combine one or more of the following approaches to establish the scope of queries accessible for display on the user interface (e.g., which chains of concepts/properties can be combined to make queries).

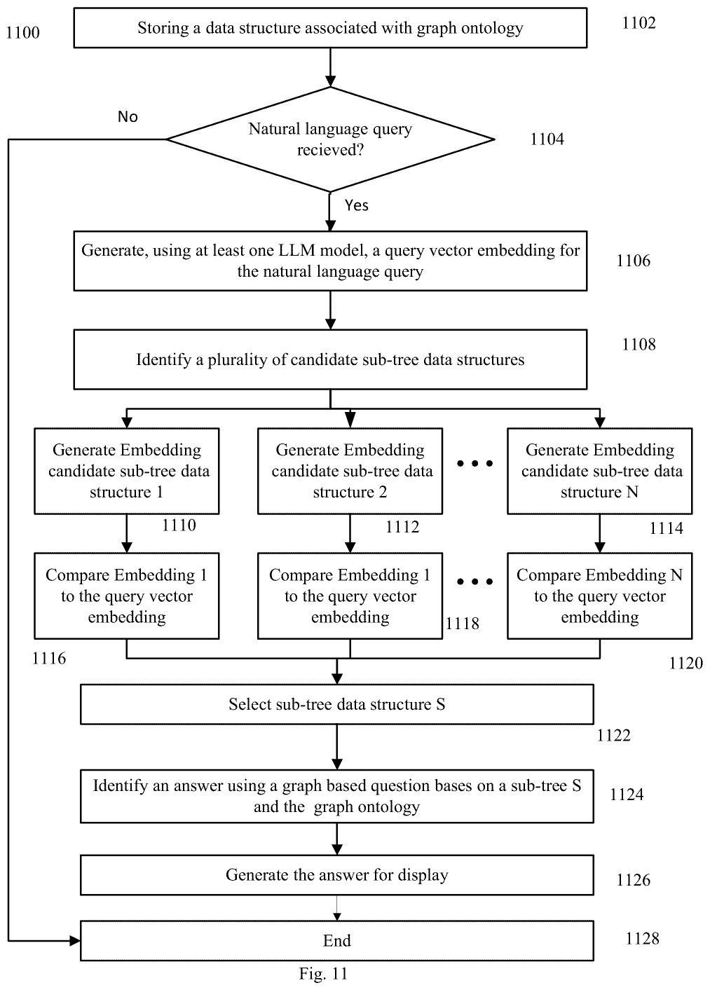

The overall flow for DPE to perform the method is described in an example flow chart of FIG. 11. In that flow chart candidate sub-graphs are selected in step 1108. More example techniques for this selection are provided herein. Once sub-graphs are created, they may be converted into vector space (e.g., with an intermediate naming step) and matched to the query embedding in the same vector space to find the set of sub-graphs that can be used to show an answer 310.

In some embodiments, the DPE may exhaustively enumerate all possible graph queries (within certain pre-defined limits, such as related to sizes of graphs). Such approaches may be used for small ontologies in some approaches. In some embodiments, the DPE may find all tree shapes in the graph up to a certain size, and all combinations of their properties and aggregates up to a limit (e.g., all queries of at most 4 concepts, each with at most 2 properties may be found). In another approach, the system may enumerate all 2- or 3-sized combinations of classes in the ontology and use a graph algorithm to provide 1 or more “shortest paths” between them. In some embodiments, the determination of classes and properties for query discovery may be handled with several steps described herein. Path finding may be performed between properties not just between classes (concepts).

In some approaches, the DPE may perform pre-query processing to prepare data and models for handling queries. In some approaches, the DPE performs the following steps:
1. Loads the ontology/knowledge model (e.g., graph 700 of FIG. 7) into a graph representation.
   a. Create a node for each class (e.g., nodes for classes 707, 718, and 719 of FIG. 7)
   b. Create a node for each property (e.g., properties 702, 704, 706, 716, 720, 722, 710, and 714 of FIG. 7)
   c. Create a node for some selection of aggregates (sum, min, max, etc.). For example, the DPE may create an aggregate node for ages of students 704 of FIG. 7.
   d. Create “hasProperty” edge from classes to properties (e.g., respective edges between 707 and 702, 704, and 706)
   e Create “has Aggregate” edge from properties to aggregates
   f. Create edges connecting classes to each other, labeled with the appropriate relationship in the ontology (e.g., following arrows 708, 720, of FIG. 7, etc.)
   g. Either populate “inheritsFrom” relationships to represent class inheritance, or recursively follow these edges and duplicate parent class properties at child classes
   h. Define “max_num_classes” and “max_props_per_class” constants to some predetermined limit

In some approaches, the DPE builds a list of “motifs”—graph patterns (e.g., Y shape pattern of classes, line pattern of classes) that may be searched to populate a master list of query patterns. In the examples below, “c”, “r”, “p”, “a” correspond to “class”, “relationship”, “property”, “aggregate”, and numbers represent different objects (c1 and c2 are different classes). Motif (c0)-[r0]->(c1) is notation indicating a pattern by which a class is connected to another class by a relationship. Each term may be used by the DPE a variable that defines a search pattern. In some embodiments, these motif templates may be defined for all tree shapes of certain sized (e.g., size 6, 7, 8, etc.)

As an example, the motif sets below may refer to a respective pattern for identifying a) all class properties, and their possible aggregates, b) all classes, and c) all class-to-class relationships (e.g., using a data structure created as shown in FIG. 1)

TABLE 1

| | |
|---|---|
| paths_pset | [[“(c)-[rp]−>(p)”, “(p)−[rpa]−>(pa)”]] |
| paths_c | [[“(c0)”]] |
| paths_cedge | [[“(c0)-[r1]−>(c1)”]] |

In addition, as an example, DPE may use a motif “paths_ctree” that enumerates all possible tree structures created by directional relations between classes, up to the “max_num_classes” limit created above.

For each of these 3 example patterns, the DPE may run a search against the ontology graph (e.g. graph 700 of FIG. 7). For example, in an example of toy database, the motif “cedge” motif would return hits for both “Set-hasTheme->Theme” and “Set-hasMinifig->MiniFigure.” Similar results may be produced by searching the graph 700 of FIG. 7.

Outputs may be stored by the system as lists of “query fragments” expressed in some suitable object notation.

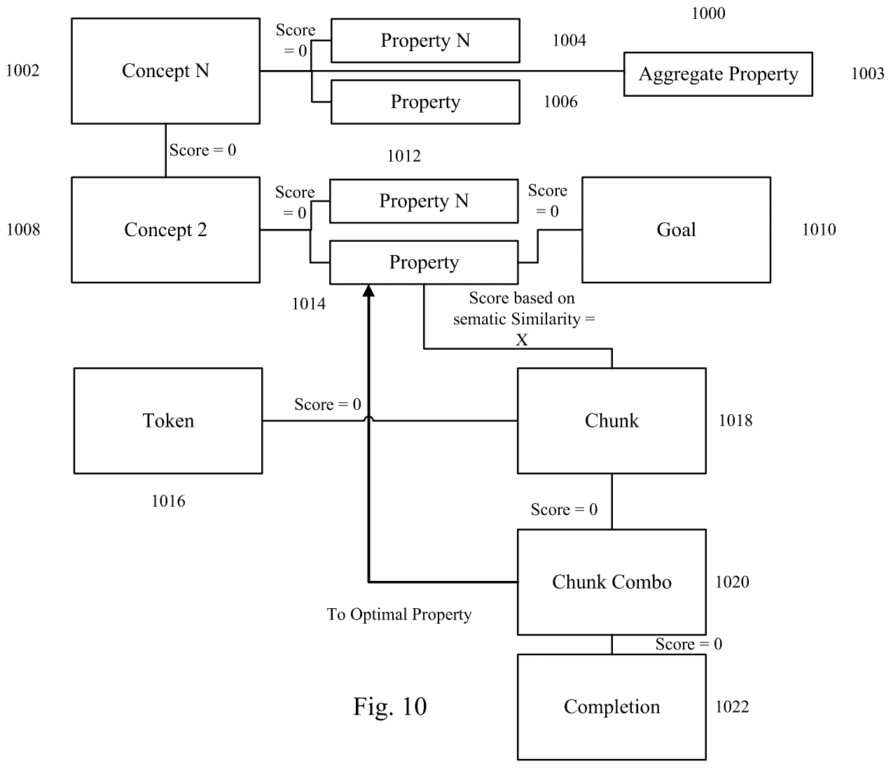

An additional technique for identifying candidate tree shapes is further described in relation to FIG. 10.

The generated results above may be a machine-readable definition of query components. In some approaches, to be discoverable using an LLM, the DPE may also generate a “semantic” description for each identifier. In some approaches this is done using heuristic algorithm, and in other approaches this is done with specially trained ML learning model that is trained to accept graph input and output semantic names. In another approach, the ML learning model may be trained to directly create embeddings from candidate tree shapes without the need for intermediate semantic descriptions.

In one approach, the DPE uses an algorithm that lists class names and their properties into a descriptive sentence, considering aggregates and how those are broken down across non-aggregated properties. For example, “Set name and Theme name” could be a description. If the system needs to count the sets for each theme (e.g., “count” is applied to the set.name property) the description might be “Count of set name by Theme name”.

In one approach, the system may feed these names to an LLM and ask it for 2-5 synonyms to generated alternative semantic descriptions. For example, the following query may be used by the DPE to input into a chat based LLM (e.g., locally or via an API): “The following is the name of a question being asked by a user. Provide five unique re-phrasings.” The rephrasing may then be used by the DPE to create embedding in the same vector space as the embedding for a query. The embedding can be used to identify candidate sub graphs (e.g., as in step 1122 of FIG. 11).

In one approach, each of the three motifs the DPE searched above will have its results stored in a vector index. (e.g., the system may create three vector indexes per ontology). To do this, for each motif/index the DPE uses a suitable embedding model to generate vector representations of the description for each motif result. For example, BAAI/bge-large-en-v1.5 may be used. Such embedding system is described in more detail in Hugging Face BAAI/bge-large-en-v1.5 page, (https://huggingface.co/BAAI/bge-large-en-v1.5) which is herein incorporated by reference. The DPE may upload each candidate result into its index with the vector, the plain English description, and the structured representation of the query fragment for future use (e.g. in step 316). In some approaches, the system may have pre-stored candidate index to be used for processing future queries. For example, the index may store all class combination, all possible properties (with reduced permutations).

The DPE may then perform Query-Time Workflow. Example process flow at query time is provided herein. Both a “tree” and “path” method (described above) are included here as examples.

In the tree approach, the following steps can be used by the DPE:
1. Receive query (e.g., via UI)
2. Convert the query to a vector space
3. Send the English user query to a vector search against the “ctree” index—this index contains structures of classes combined using relationships, but no properties. This creates a list of likely class structures.
4. Send the English query to a vector search against the “pset” index—this index contains combinations of properties and their aggregates within a single class. This returns a list of property sets that may help answer the question.
5. For each “ctree” result, the DPE iterates through “pset” looking for property sets and returns all matches. Each of these matches is a potential complete graph query that might help answer the inputted question.
6. For each query, the DPE may generate a query name/description using a method similar to that described in the Pre-Query Process above (e.g., create re-phrasings for later encoding in the same vector space that the query was converted to)
7. The DPE may then generate a vector embedding for each of these query names (in the same vector space that the query was converted to)
8. Rank the potential queries by vector comparison (e.g., using cosine distance) with an embedded version of the original user natural language query.
9. Return the top threshold number of queries
10. The queries can be displayed on the UI and/or used to find an answer using suitable SPARQL techniques or SQL techniques. In some embodiments, the queries may also be programmatically complied into SQL queries or any other suitable query for database lookups to create final results.
11. SPARQL answers (and/or SQL answers or other suitable deterministic answers) can be converted to natural language answers using an LLM.

For larger queries, the DPE may use “path” method. In some approaches, the system may run both methods concurrently and join the results to cover the broadest range of use cases.

In some embodiments, the DPE accepts the natural language (e.g., English) user interface query, and decomposes it using linguistic analysis. This is an optimization to isolate individual terms (nouns and verbs) that will give a strong semantic match to query fragments in the vector indexes. The system may use a few versions of this that group nouns with supporting nouns using linguistic libraries.

The example method continues as follows:
1. For each of these “noun clusters”, the DPE searches the “cedge” index. For each match, it adds both classes to a list of potential classes. The DPE ranks the classes based on frequency of occurrence in this generated list. (e.g., get the classes that occur most often in matches).
2. The DPE Retrieves a graph representation of the ontology (e.g., as shown in FIG. 7)
3. For each 2- or 3-size combination of the top concepts, the DPE runs a “shortest path” algorithm between the two classes in each match and turns the resulting path into a class query fragment, similar to that found in the “ctree” index.
4. the DPE combines these matches with pset matches, as above in the “tree” method. The process performed by the DPE may be the similar (from there) to the tree approach described above.

The DPE may provide UI Features, including:
1. The UI showing multiple “suggested graph queries” to use as context for the answer.
2. The UI Optionally inputs this output into an LLM for summarization

The DPE outperforms RAG LLM approaches (e.g. a showing in FIG. 2) by having much smaller vector database required (cost, performance) to store knowledge model, instead of all user data. The system also provides visual evidence in the form of a graph query (which may be an editable query)—for validation and confidence. The visual evidence interface can be interacted with to improve and change queries on the fly. The system outperforms Text2SQL/Text2Cipher systems by proving visual evidence in the form of a graph query, especially in the ability to iterate via the user interface (e.g., to discard classes, etc.) without having to edit SQL or Cipher code.

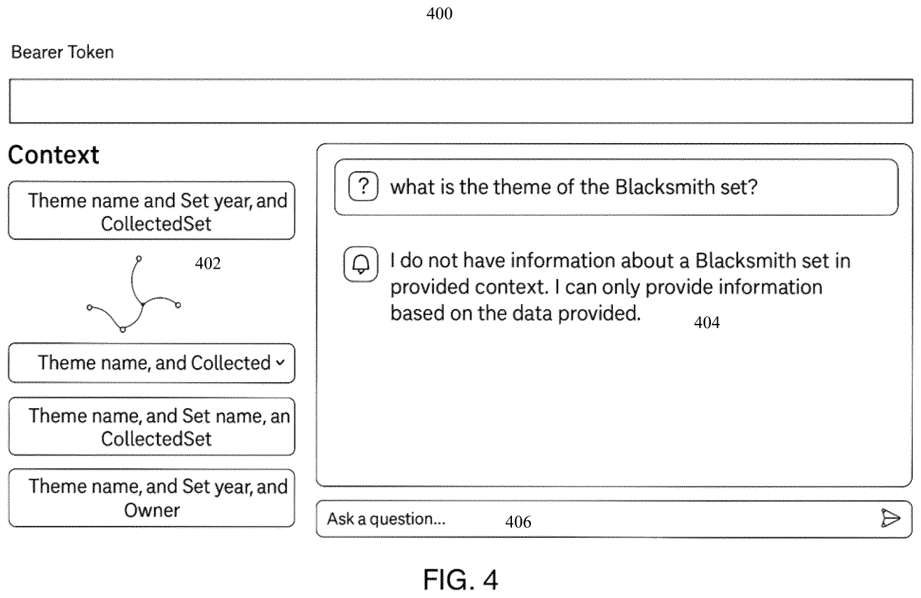

FIG. 4 shows an example User Interface 400. Based on a question 406 “What is the name of the set,” the DPE (e.g., same application as in FIGS. 1 and 3) constructs a sub-graph shown in the “context” column (e.g., as described in FIG. 3). The sub-graph is constructed using a knowledge graph as in FIG. 1 and, for example using techniques listed above. In some embodiments, the system may ask for identification of context 404 (e.g., correct semantic ontology) before proceeding which provides further confidence. In this example, graph 402 and other proposed graph-based queries are shown only when correct context is identified. Interface may show bearer token used as security for accessing the interface.

FIG. 5 shows an example User Interface 500. Based on a question 504 “What is the theme of Blacksmith set,” the DPE (e.g., same application as in FIGS. 1 and 3) constructs a sub-graph shown in the “context” column. In some embodiments, the system may ask for identification of context (e.g., correct semantic ontology) before proceeding which provides further confidence. In this example, answer 502 and other proposed graph-based queries are shown only when correct context is identified. The sub-graph 506 is constructed using a knowledge graph as in FIG. 1 and, for example using techniques listed above for identifying the sub-graph. For example, the system shows concept “Theme,” visually connected with concept “Set” with a feature “name.” This is used to look up data in the semantic overlay model (e.g., as shown in FIG. 7) and to provide a tabular answer. The tabular answer may also be used to provide a chat-based response 502 “the theme of the blacksmith set is castle.” Interface may show bearer token used as security for accessing the interface.

FIG. 6A shows a generalized embodiment of a device usable to provide data processing and visualization as described above and below. In particular, device 600 of FIG. 6A may be any of the devices that perform steps described in FIGS. 1-5. Device 600 may receive data via data network interfaces 610 and provide the received data to control circuitry 604 via an input/output (I/O) path 602. Control circuitry 604 includes processing circuitry 606 and storage 608. Storage 608 may include volatile memory 630 (such as random-access memory (RAM), for example, static RAM and/or dynamic RAM), which does not retain its contents when power is turned off, and non-volatile memory 608 (such as, for example, a solid state drive (SSD), a hard disk drive (HDD), electrically erasable programmable read-only memory (EEPROM), etc.), which does retain its contents when power is turned off. Control circuitry 604 may send and receive commands, requests, and other suitable data using I/O path 602. As noted above, I/O path 602 connects control circuitry 604 (and specifically processing circuitry 606) to network interface 610, which in turn connects device 600 to one or more other devices. For example, I/O path 602 may be used by one or more servers to receive local or remote user interface input and provide visualization output to remote devices.

Control circuitry 604 may be based on any suitable processing circuitry, such as processing circuitry 606. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, octa-core, or any suitable number of cores). In some embodiments, processing circuitry is distributed across multiple separate processors or processing units, for example, multiple of the same type of processing units (e.g., two INTEL CORE i7 processors) or multiple different processors (e.g., an INTEL CORE i5 processor and an INTEL CORE i7 processor). In some embodiments, control circuitry 604 executes instructions suitable to implement any of the techniques described above or below.

Storage 608 may be an electronic storage device that is part of control circuitry 604. As referred to herein, the phrase “electronic storage device” or “storage device” should be understood to mean any device for storing electronic data, computer software, instructions, and/or firmware, such as RAM, content-addressable memory (CAM), hard disk drives (HDDs), optical drives, solid state devices (SSDs), quantum storage devices, or any other suitable fixed or removable storage devices, and/or any combination of the same. The circuitry described herein may execute instructions included in software running on one or more general purpose or specialized processors. In some embodiments, storage 608 may include a set of instructions, that when executed by control circuitry 604, result in execution and operation of the DPE as described by FIGS. 1-8. In some embodiments, device 600 may comprise user interface circuitry for receiving user input (e.g., via keyboard, mouse, touch screen or any other suitable user input device). user interface circuitry may provide input data to control circuitry 604.

FIG. 6B shows a diagram of an illustrative system 650 for performing data analysis and user interface presentation, in accordance with embodiments described in FIGS. 1-11. For example, system 650 includes any number of servers 656-658 that may be configured to perform all aspects of the DPE as described above and below. For example, the DPE may be executed by any of the servers 656-658 or by a combination of servers using suitable distributed computing techniques. Servers 656-658 may be communicatively connected to any number of databases 652-654 by local connection or via network 660. Network 660 may be any kind of a suitable network, such as Internet, intranet, private network, virtual network, cellular network, or any combination the above.

System 650 may include any number of client devices 662-666 (e.g., PCs, computers, smartphones, laptops, PDA or any other suitable computer devices). Client devices 662-666 may be configured to interface with servers 656-658 via network 660. Client devices 662-666 may be configured to provide UI input to servers 656-658, e.g., to define the semantic overlay data structure for traditional data sources (e.g., stored on Databases 652-654). Client devices 662-666 may be configured to provide query input to the DPE executing on servers 656-658. Client devices 662-666 may be configured to receive output provided by the DPE executing on servers 656-658. For example, client devices 662-666 may display visualizations and query results provided by the DPE generated for display by servers 656-658 via network 660. Each of devices 662-666, 656-658, and 652-654 may comprise hardware as shown by FIG. 6A and/or any other suitable hardware.

FIG. 8 shows an interface 800 of DPE (e.g., same application as described in FIGS. 1 and 3) for receiving text or voice questions and providing answers. For example, a question 860 “What is the theme of the Iron Man Toy.?” In another example, question “Who are the students of biology teacher in Washington High School?” is received.

The DPE creates a graph sub-graph 860, e.g., as described above. For example, sub graph 860, may be best matching sub graph that was identified using techniques described in FIG. 3. For example, the sub graph may have concept 852 with leaf property 850 and concept with leaf property 854, with an applied filter 853. In this case, the graph clearly shows to the user the system will search class “themes” with certain names that are connected to concept toy set with certain names, that will be filtered by filter “iron man” 853. In this way the user is assured that the resulting answer (e.g., data 805) are verifiable. The user also sees text representation of the graph-based questions 804. The user interface may be used to click buttons 805 to see underlying tabular data.

In another example, the graph 880 may include concepts School 802, concept teacher, and concept Student (which may include features Name and Student ID.” Connections 808 may also be shown. The graph sub-graph shows the user that the query was correctly interpreted and thus that the system is on the right track and is considering correct data sources. The DPE may also provide a tabular answer. The system may also provide a chat-based answer “A: The Student of the biology teacher are Bob Jones and Matt Smith” (e.g., using an LLM as described above).

In some approaches, the user may interact with the graph 880 to change concepts and features. This may result in the change to the query on the right. In this way the system may iterate between changes to text and to graphs. In some embodiments, the DPE mays also show context 802 which may include both other graph subsets that ranked highly and/or historical user constructed queries that are similar to other generated queries. The UI may allow selection of any of these queries to be run using SPARQL search (or and SQL search) with results shown on the interface.

In some embodiments, the graph sub-graph may show troubleshooting data, e.g., as described in U.S. Pat. No. 12,079,212. For example, connection warning or concept warning may be shown. The user may click warnings to see what the problem is (e.g., no data or sparse data). In some embodiments, the system may show alternative lineage views for the question.

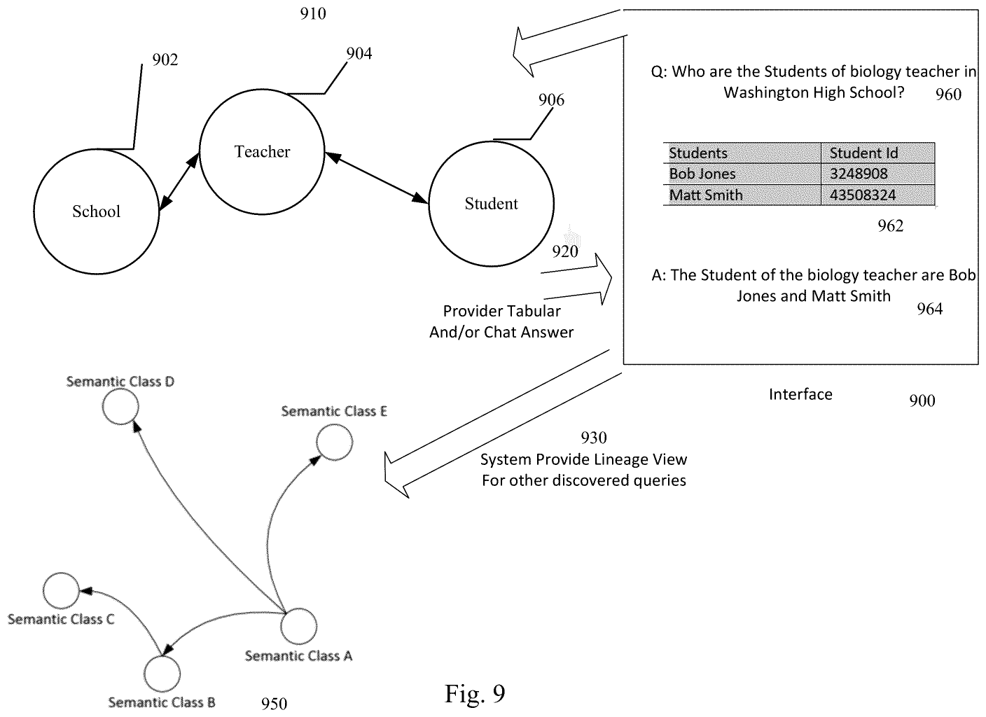

FIG. 9 shows another example User Interface 900 for the DPE (e.g., DPE of FIGS. 1 and 3). The User Interface 900 shows an optional integration of linguistic analysis (the sentence structure of the question) with graph queries to get better results. The system may also handle integration of unstructured documents. In this example, names of concepts and features are shown in different font in context used to process the query. The links to view the used data is also provided in addition to the final answer.

For example, user question 960 in natural language form may lead display of semantic query in graph form 910. The semantic query 910 may have been selected using query discovery techniques described above with respect to FIG. 3. The semantic query 910 may be used by DPE to show tabular data 962 (e.g., based on filtered instance data e.g., as described for FIG. 7) on the user interface. In some examples, the tabular data 962 may be used by the DPE to generate natural language answer 964 (e.g., by inputting the tabular data into an LLM).

In some embodiments, DPE may also show other top ranking sub graphs (e.g., 950) as context).

FIG. 10 is an illustrative example of generating candidate graphs for a natural language-based query, in accordance with some embodiments. For example, DPE (e.g., same DPE as in FIGS. and 1 and 3) may perform the steps described below as part of generating candidate sub graphs (e.g., as step 1108 in FIG. 11). In some embodiments, this approach is an alternative workflow for finding the best graph queries from a semantic model, based on a user question posed in natural language (e.g., as shown in FIG. 3).

In some embodiments, at Step 1, the DPE creates an “analysis graph” 1000 from the semantic model (e.g., model 700 of FIG. 7), including the node types “ ”, “Concept” (or class), and “Property.” For example, nodes 1002 and 1008 are created for the concepts (there may be any number of nodes), and nodes 1006-1004 and 1014-1012 are created for properties (there may be any number of properties 1-N). Concepts and Properties nodes are connected by edges. Concepts may have node links to other concepts (e.g., as shown between 1002 and 1008), these may be based on connections shown in FIG. 7.

In some embodiments, at Step 2 an “analysis graph” is accessed by the DPE with Concepts, Properties, and connections between them. Additionally, Property nodes (e.g., node 1003) may be created by the DPE for a variety of common pre-selected “aggregates”: [Sum, Average, Min, Max, etc.]. Additionally, every Property may be connected to a single node called “Goal” 1010.—in some approaches, names of properties may be modified to include the name of the concept as well. A concept Student with property Name will have a property in the graph with label “student name.” At this step, each edge in this graph has a “score” attribute, and all these values are set to 0.

In some embodiments, at Step 3 Natural Language Processing is applied by the DPE to the user question (e.g., query 302 of FIG. 3). Based on this the following steps are performed by the DPE
1.—A “token” node (e.g., 1016) is added to the analysis graph for every token (useful word) in the user question. Tokens may be created by an LLM.
2.—A “chunk” node (e.g., 1018) is added for every “noun chunk” in the question—this groups together nouns and modifiers into related groups
3. A “chunk” node is also added for every compound structure (“AND”s and “OR”s) between noun tokens. For example, if the input includes a term “brick & mortar store” the system may add chunks for “brick” “mortar,” “brick+mortar,” “brick store,” “mortar store,” etc.
4. Edges are added to the graph to connect tokens to the chunks that contain them. Tokens and chunks are, for now not connected to the rest of the graph.

In some embodiments, at Step 4—the DPE adds relations between Property nodes and Chunk. These edges may be added based on following steps:
1.—the DPE uses LLM vectors to encode the labels of properties (e.g., combined labels)
2. The DPE uses LLM vectors to encode names of chunks
3. The DPE compares all chunks to all properties (using vectors) and add a “represents property” edge (e.g., edge between 1018 and 1014) to the graph with a “score” equal to the similarity score (cosine distance) between the respective vectors.
4. In some approaches, when doing this, the DPE may first compare each chunk to the aggregate nodes (Sum, Average, etc.). Then, the DPE only add chunk to property relationships whose similarity is higher than the best similarity to an aggregate. This eliminates chunks-property connects that are more likely to refer to an aggregate than a property or concept.

In some embodiments, at Step 5—the DPE—Add “chunk combos” (e.g., node 1022) to the graph 1000. For example, the DPE may create a list of all possible combinations of the chunks (e.g., Brick/mortar and Brick/brick& mortar). Such chunk combos may include varying lengths of combinations, for example, if there are 5 chunks, there will be 5 combinations of length 1, 1 combination of length 5, etc., The DPE then add each chunk comb node to the graph for each chunk combo.

In some embodiments, at Step 6, the DPE adds “completions” (e.g., node 1022) to the graph 1000. A completion may be a set of chunk combos that may be useful for creating a query. Each chunk combination may be in more than one completion. The DPE may create a completion for every possible combination of “chunk combos”, however the DPE may discard any completion that has multiple chunk combos containing the same chunk (ensuring no overlap). In this way, the DPE is trying to find chunk combos (i.e., groupings of words) that tie to concepts/properties in the model, by creating completions that represents a potential mapping between portions of the user's NLP question and elements of the semantic model that might satisfy it.

In some embodiments, at Step 7 the DPE evaluates “flows” through the created graph 1000. At this point, in analytical graph 1000, all edges have score=0 except the chunk to property relations (e.g., edge 1018-1014) have a similarity score computed based on vector analysis (e.g., a score between 0 and 1). To calculate a “flow” the DPE evaluates all possible combinations of chunk combo and property (for each context the chunk combination is connected to). For example, for each pair, the DPE will find all paths in the graph (chunk_combo->chunk->property->goal). For each path (flow), the DPE will find the total path weight (in this case, equal to each traversed chunk->property similarity). The DPE will compute the summation of these path weights for each chunk combo and property pair (for each competition the chunk combo is in). In some approaches, pairs with many paths of low weight will add up to larger flow scores but so will pairs with small numbers of paths with high similarity scores. The DPE may use these scores to represent “how well connected is this chunk combo to this property?” In other words, “how well does this cluster of words represent this model property?” The DEP may temporarily store a lookup table of the flow for every combination of chunk combos and properties (for each completion the chunk combo is in).

In some embodiments, at Step 8 the DPE performs Combo to Property Optimization. The “best” match between a chunk combo and a property might be interpreted differently by the DPE depending on which other chunk combos are in each completion. For this reason, the DPE may optimize chunk combo to property flows (and thus likelihood of connection) for each completion. In some examples, for each completion, the DPE will find the maximum flow from one of its combos to a property. This is the best match between a combo and a property for this solution. DPE may then remove that combo and property from consideration, and iteratively (e.g., recursively) continue making best match calculations until all chunk combos have been paired 1-1 to a property. This edge is added to the graph (e.g., edge 1020-1014). In some embodiments this edge stores the combined weight and metadata of the corresponding completion.

For example, for each of these best matches, a relationship “chunk combo optimum property” is added to the graph connecting the chunk combo to the property. Because these matches are tied to a completion (and a chunk combo may be in multiple completions) the identifier for the completion is added to the graph edge as “context” metadata.

In some embodiments, at Step 9, the DPE performs Completion Scoring. For example, for each completion, the DPE calculates the average flow for optimized combo->property relationships, the total number of chunks, total number of properties, and some other metrics. Using these, the DPE may calculate, for example, these scores:
normal_score=avg_flow*min_flow*num_props where avg_flow is Average of links such as 1020-1014, min_flow is a lowest score for such a link, and*num_props is total number of properties linked by the completion via various paths.

$$ratio\_score = avg\_flow * num\_props / chunk\_count$$

$$sized\_score = num\_props * avg\_flow * ( avg\_flow * num\_props - max\_flow ) / ( num\_props - 1 )$$

$$length\_score = avg\_flow * ( num\_props / max\_length )$$

In some embodiments, these different scores have been found to be useful in identifying different classes of questions-simple ones, highly analytical ones, etc. In an example, the DPE will take completions ranked by all four scores. (20 completions total, top 5 from each score and then eliminate duplicates)

In some embodiments, at Step 10 the DPE may perform Concept Graph Building (e.g., creates linear and tree-shaped candidate sub-graphs used in FIG. 3 and in step 1108. The DPE may go back to the original “model graph” (e.g., graph of FIG. 7) and get a sub-graph containing only property and relation edges. For example, the model graph now has only Concept and Properties, with edges between them and Concept->Concept edges. For each completion, the DPE may make a list of the concepts attached to all the properties it contains. The DPE may Get all combinations of size 2 (i.e., pairs) of these concepts, and for each get all shortest paths in the model graph. The DPE may Calculate “gross_paths” as the array product of all possible paths for every concept pair. For a given completion, gross_paths is now a list of all possible options for how the essential concepts can be wired together. This includes intermediate concepts that might be necessary to complete paths between other concepts. or each entry in gross_paths, the DPE may call it a “solution” and add basic metadata like the number of concepts, total length of the path to connect them, etc. The DPE may then evaluate which solution is “best” based, for example, on simplicity (lower number of concepts), shortest path length, other suitable criteria etc.

In some embodiments, the DPE may also vector match the concept names in the solution and match them against the original user question. This gives the possibility of semantically matching an intermediate node better against the original question. At the end of this step, the DPE has a solution for each completion—the exact path in the model (complete with intermediate concepts) needed to tie together the properties (and their attached concepts) matched above in combo to property flow scoring.

In some embodiments, the DPE may as Step 11 perform Word assignments. For each “best” solution, the DPE may get a sub-graph of the analytical graph removing a) chunk_combos that don't apply to the current completion, b) concept-to-concept relations, and c) chunk_combo to property relations that aren't in the context of the current completion. The DPE, using this graph, matches each word/token in the user query with a concept based on the shortest path. The DPE may, using stats gathered earlier on words in the user question not directly tied to properties, the DPE may not look to associate these unused words to the nearest (both semantically, and using sentence structure) concept/property. They may be useful as named entities for filtering. For example, unused tokens may be evaluated for being filters.

For example, the user query “For Aircraft 12345, get the engine serial numbers” might tie “Aircraft” in the question to a concept called “aircraft” and “engine serial number” (a chunk combo) to the appropriate concept/property. This leaves “12345” which likely doesn't relate nicely to any given property in the model. So, the DPE may determine that “12345” likely useful for filtering Aircraft in this case. Which may be added as filter, like filter 853 of FIG. 8. To avoid using filler words such as “please, “maybe” etc., the system may use an LLM to gently rephrase the initial query. Only words that persists in the paraphrasing may be used as filters in some embodiments.

In some embodiments, the DPE may as Step 12 perform Final sorting. For each solution, the DPE may compare the “tree” view of the query and confirm they do not overlap, eliminating duplicates if required. The DPE may use a heuristic or LLM algorithm to generate a name for the query represented by the tree of concepts and properties (e.g., similarly to semantic descriptions described in FIG. 3). The DME may then compare these generated names to the original user question, returning top options as desired. The resulting candidate sub-graphs may then be used to find best ones using techniques described in FIG. 3, allowing the method to proceed to next steps of answering questions.

FIG. 11 is a flowchart of an illustrative method for answering a natural language based query, in accordance with some embodiments. For example, the method 1100 may be performed by any of devices, 600, 656, 658, 662, 664, 666 of FIG. 6. For example, such devices may run a DPE (stored as instructions in memory 608 of FIG. 6). For example, control circuitry 604 may perform these steps as described to receive questions, process them using memory 608, and output results using I/O path 602 or network interface 610.

In some embodiments, at step 1102, control circuitry stores, in one or more memories, a data structure corresponding to a graph ontology (e.g., as shown in FIG. 7) comprising a plurality of concept nodes, associated property nodes, links among concept nodes, and instance data for a plurality of instances of each concept node.

In some embodiments, at decision step 1104, control circuitry determines whether a natural-language query has been received via a user interface (e.g., I/O path 602 or network interface 610) or programmatic API. If no query is detected, the control circuitry returns to monitoring or ends at 1128; otherwise flow proceeds to step 1106.

In some embodiments, at step 1106, control circuitry generates, using at least one LLM model or LLM-backed encoder, a query vector embedding that represents the semantics of the received natural-language query (e.g., as described in FIG. 3).

In some embodiments, at step 1108, control circuitry identifies a plurality of candidate sub-graph data structures within the graph ontology that could satisfy the information need implied by the query. This may be performed using one or more techniques of FIG. 3 or the technique described in FIG. 10.

In some embodiments, at step 1110, control circuitry generates a first candidate embedding corresponding to candidate sub-graph data structure 1 using the at least one LLM model.

In some embodiments, at step 1112, control circuitry generates a second candidate embedding corresponding to candidate sub-graph data structure 2 using the at least one LLM model.

In some embodiments, at step 1114, control circuitry generates an Nth candidate embedding corresponding to candidate sub-graph data structure N using the at least one LLM model. This may also be done for any sub graphs between 1 and N.

In some embodiments, at step 1116, control circuitry compares the first candidate embedding to the query vector embedding using a vector-similarity metric (e.g., cosine similarity) to obtain a first similarity score.

In some embodiments, at step 1118, control circuitry compares the remaining candidate embeddings (including the second and Nth embeddings) to the query vector embedding using the vector-similarity metric to obtain respective similarity scores. This may also be done for any embedding between 1 and N.

In some embodiments, at step 1120, control circuitry selects a particular candidate sub-graph data structure S based on the similarity scores. In some embodiments, other candidate sub-graph data structure are picked for context.

In some embodiments, at step 1122, control circuitry generates an ontology-based usable query by compiling the selected sub-graph S into a query format suitable for the backing store (e.g., SPARQL for RDF triple stores), optionally incorporating deterministic filters derived from residual terms in the user query (e.g., determined as described in FIG. 10).

In some embodiments, at step 1124, control circuitry executes the ontology-based query against the graph-ontology store (e.g., as shown in FIG. 7) and identifies an answer using results obtained from the sub-graph S and the graph ontology.

In some embodiments, at step 1126, control circuitry generates for display or transmission the answer for display (e.g., as shown in FIG. 8), which may include a natural-language summary produced from the structured results, and may further include the intermediate sub-graph visualization, the compiled query, and confidence/coverage indicators. The display may also display other highly scoring queries for context (e.g. as shown in relation to element 802 of FIG. 8). Display or transmission may be performed using e.g., I/O path 602 or network interface 610.

In some embodiments, responsive to user confirmation or correction of classes/properties presented with the answer, control circuitry iterates one or more of steps 1108-1126 to refine the selected sub-graph, regenerate the ontology-based query, and update the displayed answer.

In some embodiments, control circuitry generates, for display, a representation of the ontology-based query used to produce the answer (e.g., a visual sub-graph of concepts, properties, joins, and filters, or a textual SPARQL/Cypher view). The control circuitry receives, via a user interface, at least one modification to the representation (e.g., add/remove a property, adjust a filter, change an aggregation, or replace a relation), compiles the modified representation into an updated executable query, executes the updated query against the knowledge-graph store, and generates for display an additional answer based on the modification.

In some embodiments, the control circuitry generates a natural-language answer by providing the structured results (and optional metadata such as lineage and coverage) as input context to at least one LLM model, which produces a narrative explanation while preserving references to the underlying tabular output.

In some embodiments, responsive to a request for more data received via interaction with the displayed representation of the ontology-based query (e.g., selecting a node, edge, or “show rows” control), the control circuitry generates for display a table-based view of at least a portion of data that was used to generate the ontology and/or the answer. The portion is selected based on the ontology-based query, such as rows mapped to a selected concept instance, property values participating in a filter, or join keys underlying a displayed relation.

In some embodiments, for a particular candidate sub-graph, the control circuitry creates a heuristic semantic description and uses at least one LLM model to generate a set of re-phrasings of the description, and generates a candidate embedding from the set (e.g., by embedding each re-phrasing and pooling or by selecting a highest-quality paraphrase) to obtain a robust representation.

In some embodiments, the control circuitry generates candidate sub-graph data structures by performing exhaustive permutations over the graph ontology, including alternative selections of concepts, properties, and relations consistent with schema constraints, thereby enumerating a comprehensive candidate set.

In some embodiments, the exhaustive permutation is bounded by a threshold length, such as a maximum number of nodes, edges, or aggregated properties, to control computational complexity while retaining semantically useful sub-graphs.

In some embodiments, the control circuitry identifies preliminary matches between portions of the natural-language query and a set of properties of the ontology's concepts (e.g., via lexical and/or semantic matching) and generates candidate sub-graphs that connect the matched properties. Unmatched query terms may be retained as deterministic filters applied during query compilation.

The above-described embodiments of the present disclosure are presented for purposes of illustration and not of limitation, and the present disclosure is limited only by the claims that follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real-time. It should also be noted, the systems and/or methods described above may be applied to, or used in accordance with, other systems and/or methods.

What is claimed is:

1. A method comprising:
storing a data structure associated with graph ontology, wherein the graph ontology comprises:
a plurality of concept nodes, wherein each of concept node of the plurality of concept nodes is connected to respective one or more property nodes;
a plurality of links, wherein each link of the plurality of links connects two concept nodes of the plurality of concept nodes;
wherein the data structure comprises data for plurality of instances of each concept node;
receiving a natural language query;
generating, using at least one LLM model, a query vector embedding for the natural language query;
identifying a plurality of candidate sub-graph data structures in the graph ontology;
generating, using at least one LLM model, a set of respective candidate embeddings for the plurality of candidate sub-graph data structures;
selecting a particular candidate sub-graph data structure based on vector comparisons of the set of respective candidate embeddings to the query vector embedding; and
generating an ontology based query for the data structure associated with the graph ontology;
generating for display an answer that is based on the ontology based on analyzing the graph ontology and the plurality of instances using the ontology based query.

2. The method of claim 1, further comprising:
generating for display a representation of the ontology based query, that is used to the generate the answer;
receiving via a user interface at least one modification to the representation of the ontology based query; and
generating for display an additional answer based on the modification.

3. The method of claim 2, further comprising:
generating a natural language answer based on the answer, wherein the natural language is generated by the at least one LLM model based at least in part on input of the answer.

4. The method of claim 2, further comprising:
receiving via the user interface a request for more data by interaction with the representation of the ontology based query;
generating for display a table based view of at least a portion of data that was used to generate the data structure, wherein the at least a portion of the data is selected based on the ontology based query.

5. The method of claim 1, wherein a particular respective candidate embedding of the set of respective candidate embeddings is generated by:
creating a heuristic based semantic description for the particular candidate sub-graph data structure corresponding to the particular respective candidate embedding;
generating, using the at least one LLM model, a set of re-phrasing of the semantic description; and
generating, using the at least one LLM model, the particular respective candidate embedding based on the a set of re-phrasing.

6. The method of claim 1, wherein the candidate sub-graph data structures are generated based on exhaustive permutations of graph ontology.

7. The method of claim 1, wherein the candidate sub-graph data structures are generated based on exhaustive permutations of the graph ontology up to threshold length.

8. The method of claim 1, wherein the candidate sub-graph data structures are generated based on preliminary matches of parts of the natural language query to a set of properties of the concepts of the data structure, and generating a set of sub-graphs connecting some properties of the set of properties.

9. The method of claim 1, wherein the candidate sub-graph data structures are generated based on algorithm that comprises:
creating an analysis graph based on the graph ontology,
setting weights of all existing links to zero;
adding chunks of the natural language query to the analysis graph;
connecting each chunk to a respective property by a respective new link, and setting the weight of the respective new link to a value determined by semantic comparison of the chunk and the respective property; and
adding chunks nodes combination to the analysis graph;
adding completion nodes to the analysis graph based on every possible combination of chunks nodes with no overlap; and
evaluating flows from the completion nodes to identify the candidate sub-graph data structures.

10. The method of claim 1, wherein the candidate sub-graph data structures are generated based on algorithm that comprises:
creating an analysis graph based on the graph ontology,
setting weights of all existing links to zero;
adding chunks of the natural language query to the analysis graph;
connecting each chunk to a respective property by a respective new link, and setting the weight of the respective new link to a value determined by semantic comparison of the chunk and the respective property; and
adding nodes representing all combinations of chunks to the analysis graph;
adding completion nodes to the analysis graph based on every possible combination of chunks nodes with no overlap; and
evaluating flows from the completion nodes to identify the candidate sub-graph data structures.

11. A system comprising:
memory configured to:
store a data structure associated with graph ontology, wherein the graph ontology comprises:
a plurality of concept nodes, wherein each of concept node of the plurality of concept nodes is connected to respective one or more property nodes
a plurality of links, wherein each link of the plurality of links connects two concept nodes of the plurality of concept nodes
wherein the data structure comprises data for plurality of instances of each concept node;
I/O circuitry configured to:
receive a natural language query;
control circuitry configured to:
generate, using at least one LLM model, a query vector embedding for the natural language query;
identify a plurality of candidate sub-graph data structures in the graph ontology;
generate, using at least one LLM model, a set of respective candidate embeddings for the plurality of candidate sub-graph data structures;
select a particular candidate sub-graph data structure based on vector comparisons of the set of respective candidate embeddings to the query vector embedding; and
generate an ontology based query for the data structure associated with the graph ontology;
generate for display an answer that is based on the ontology based on analyzing the graph ontology and the plurality of instances using the ontology based query.

12. The system of claim 11, wherein the control circuitry is further configured to:
generate for display a representation of the ontology based query, that is used to the generate the answer;
receive via a user interface at least one modification to the representation of the ontology based query; and
generate for display an additional answer based on the modification.

13. The system of claim 12, wherein control circuitry is further configured to:
generate a natural language answer based on the answer, wherein the natural language is generated by the at least one LLM model based at least in part on input of the answer.

14. The system of claim 12, wherein the control circuitry are further configured to:
receive via the user interface a request for more data by interaction with the representation of the ontology based query; and
generate for display a table based view of at least a portion of data that was used to generate the data structure, wherein the at least a portion of the data is selected based on the ontology based query.

15. The system of claim 11, wherein a particular respective candidate embedding of the set of respective candidate embeddings is generated by:
creating a heuristic based semantic description for the particular candidate sub-graph data structure corresponding to the particular respective candidate embedding;
generating, using the at least one LLM model, a set of re-phrasing of the semantic description; and
generating, using the at least one LLM model, the particular respective candidate embedding based on the a set of re-phrasing.

16. The system of claim 11, wherein the candidate sub-graph data structures are generated based on exhaustive permutations of graph ontology.

17. The system of claim 11, wherein the candidate sub-graph data structures are generated based on exhaustive permutations of the graph ontology up to threshold length.

18. The system of claim 11, wherein the candidate sub-graph data structures are generated based on preliminary matches of parts of the natural language query to a set of properties of the concepts of the data structure, and generating a set of sub-graphs connecting some properties of the set of properties.

19. The system of claim 11, wherein the plurality of candidate sub-graph data structures is pre-generated prior to receiving the natural language query.

20. The system of claim 11, wherein the candidate sub-graph data structures are generated based on algorithm that comprises:
creating an analysis graph based on the graph ontology;
setting weights of all existing links to zero;
adding chunks of the natural language query to the analysis graph;
connecting each chunk to a respective property by a respective new link, and setting the weight of the respective new link to a value determined by semantic comparison of the chunk and the respective property; and
adding nodes representing all combinations of chunks to the analysis graph;
adding nodes representing all combinations of chunks to the analysis graph;
adding completion nodes to the analysis graph based on every possible combination of chunks nodes with no overlap; and
evaluating flows from the completion nodes to identify the candidate sub-graph data structures.
